(19) United States
(12) Patent Application Publication
(10) Pub. No.: US 2006/0236215 A1
(43) Pub. Date: Oct. 19, 2006

(54) Method and system for automatically creating document

(76) Inventors: Jenn-Sheng Wu, Hsin Chu City (TW); Jung-Mao Chien, Tao Yuan City (TW)

Correspondence Address: RABIN & BERDO, P.C., Suite 500, 1101 14 Street, N.W., Washington, DC, 20005, US

(21) Appl. No.: 11/105,512

(22) Filed: Apr. 14, 2005

(51) Int. Cl. G06F 17/00

(52) U.S. Cl. 715/500

(57) ABSTRACT

The present invention describes a method and a system for automatically creating document. The present invention relates to a method and a system for creating certain electronic document specified for document by mapping from items of catalog sample document to automatically create electronic documents. A system for automatically creating document of the present invention has a document catalog management module, a catalog sample document choosing module, a catalog document list creating module, a catalog and document corresponding module and a document incorporating module. The method and the system of the present invention are configured with the capability of searching for an electronic document stored in the electronic storage device so that the electronic document can be re-used. Besides, it spends less time in automatically incorporating documents. Thus, regarding efficiency of creating document, the present invention dominates.

### BACKGROUND OF THE INVENTION

1. Field of the Invention

The present invention relates to a method and a system for automatically creating a document, and in particular to a method and a system for creating a certain electronic document object specified for a document by mapping from items of a catalog sample document to create automatically electronic documents.

2. Description of Related Art

With development of information technology, a document is edited by a word processor instead of manually, and electronic documents are common. There are some problems in manually drafting documents, such as, for example, misspellings or grammar errors. However, the electronically prepared document is checked by a document information system so that the possibility of the above problems is significantly lowered.

In the Internet era, it is not uncommon to make use of and share resources. For convenience, software companies provide catalog templates for several documents (e.g. PowerPoint). Users can choose a catalog template and edit the template to create a document. In the prior art, electronically editing a document is inconvenient in many ways.

### SUMMARY OF THE INVENTION

It is an object of the present invention to provide a method and a system for automatically creating a document. In particular, the present invention relates to a method and a system for creating an electronic document by mapping from items in the sample document catalog to create automatically electronic documents.

A system for automatically creating a document of the present invention includes: a document catalog management module, a catalog sample document choosing module, a catalog document list creating module, a catalog and document corresponding module, and a document incorporating module. The document catalog management module and the catalog sample document choosing module create and choose certain electronic sample documents. Then, keywords are input by the catalog document list creating module through a search engine so as to search for certain electronic document objects stored in electronic storage equipment. By using the catalog and the document corresponding module, items of the catalog sample document and the certain electronic document objects are mapped, connected and incorporated. Thus, an electronic is created by repeating the above procedure.

According to the present invention, the method for automatically creating document includes the steps of: (A) choosing a catalog sample document by a catalog sample document choosing module; (B) verifying whether the catalog sample document meets requirements; (C) using a catalog document list creating module to find an electronic document object list through a search engine; (D) using a catalog and document corresponding module to map from at least one certain electronic document object to the items of the catalog sample document; (E) using a document incorporating module to convert a document format of the certain electronic document object by a document format conversion engine; and (F) modifying the incorporated document with an electronic editor. If the incorporated document is not yet completed, then the process from step (C) to step (F) is repeated.

According to the system and method for automatically creating document of the present invention, the present invention generates a catalog sample document and searches for an existent certain electronic document object. By mapping, the certain electronic document is combined with and incorporated into the certain catalog sample document. The document is then edited by an electronic editor.

### BRIEF DESCRIPTION OF THE DRAWINGS

The present invention can be fully understood from the following detailed description and preferred embodiment with reference to the accompanying drawings, in which:

FIG. 1 illustrates a block diagram of a system for automatically generating document according to the present invention;

FIG. 2 schematically illustrates a catalog sample document according to one embodiment of the present invention;

FIG. 3 schematically illustrates a document mapping management according to one embodiment of the present invention;

FIG. 4 schematically illustrates a document of one embodiment of the present invention;

FIG. 5 is flowchart showing a method for automatically creating a document according to one embodiment of the present invention; and

FIG. 6 is a flowchart showing a method for automatically creating a document according to another embodiment of the present invention.

### DETAILED DESCRIPTION OF THE PREFERRED EMBODIMENTS

The following detailed description is of the best presently contemplated modes of carrying out the invention. This description is not to be taken in a limiting sense, and is made merely for the purpose of illustrating general principles of embodiments of the invention. The scope of the invention is best defined by the appended claims.

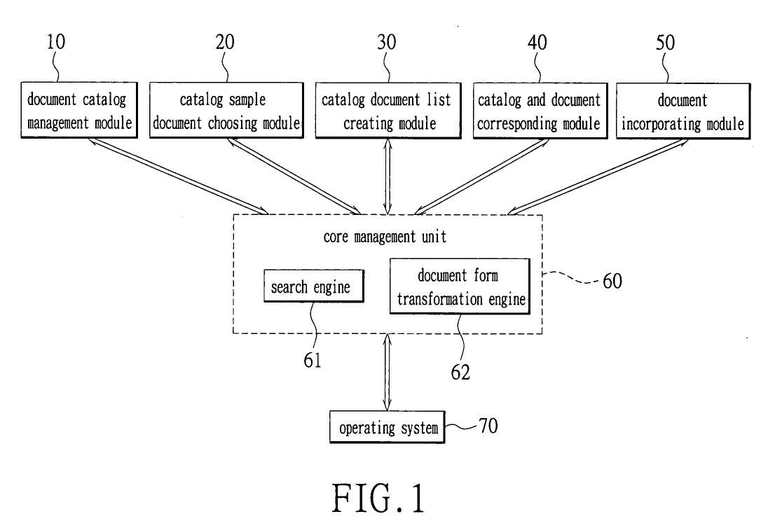

Reference is made to FIG. 1. FIG. 1 illustrates a block diagram of a system for automatically generating document according to the present invention. An operating system 70 (e.g. Windows 98/Me/2000/XP) has a core management unit 60. The core management unit 60 communicates with five management modules with different functions, and these management modules include a document catalog management module 10, a catalog sample document choosing module 20, a catalog document list creating module 30, a catalog and document corresponding module 40 and a document incorporating module 50. The core management unit 60 consists of a search engine 61 and a document form conversion engine 62. The features of the present invention are described in detail below.

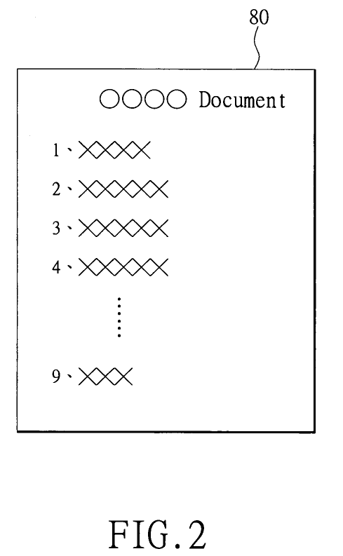

Reference is made to FIG. 2. FIG. 2 schematically illustrates a catalog sample document according to one embodiment of the present invention. The document catalog management module 10 is used to create and save the catalog sample document information. The catalog sample document choosing module 20 is used to choose a catalog sample document 80, and the catalog document list creating module 30 defines scope of document searching. The scope indicates the users have a right to access the area and the document is stored in an electronic device by an electronic file catalog, such as, for example, Internet, intranet, local area network or personal computer. A full text search condition is compatible with a character set of certain character configuration (e.g. UTF-8 unicode) and used to search for a document through the search engine 61. The document is electronically stored in the electronic storage device.

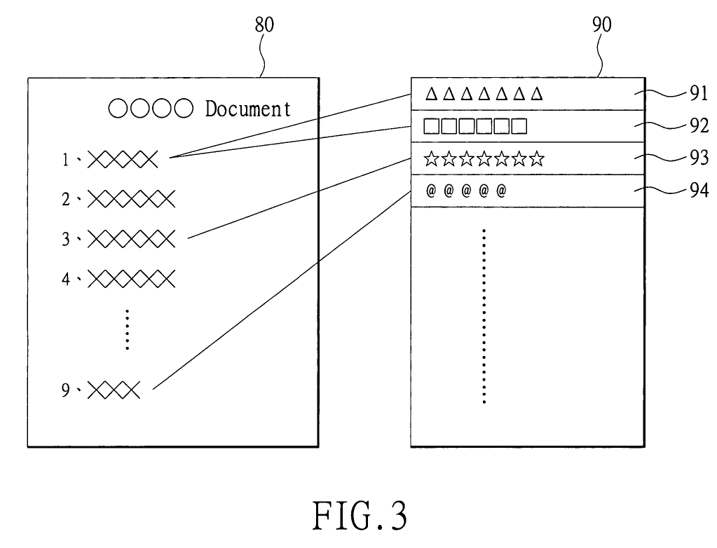

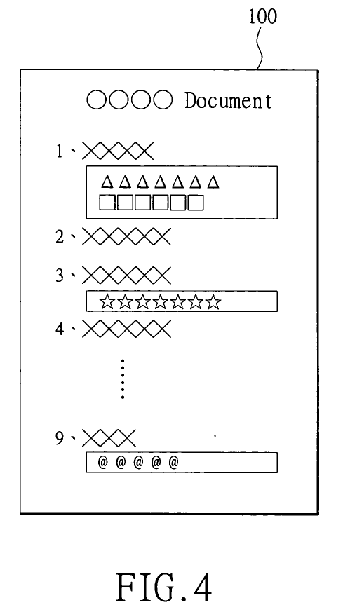

Reference is made to FIG. 3. FIG. 3 schematically illustrates document mapping management according to one embodiment of the present invention. The catalog and document corresponding module 40 is used to preview certain electronic document objects 91, 92, 93 and 94 of an electronic document object list 90 and chooses at least one certain electronic document object mapped to items of the catalog sample document 80 (connected by solid lines). FIG. 4 schematically illustrates a document of one embodiment of the present invention. When the certain electronic document is chosen, the document incorporating module 50 defines the form of an incorporated document 100 (e.g. MS-Office suite, XML. ASP or HTML) by mapping. The certain electronic document object is converted into the form of the incorporated document 100 by the document form conversion engine 62 and incorporated into the incorporated document 100. Then, content of the incorporated document 100 is subsequently edited.

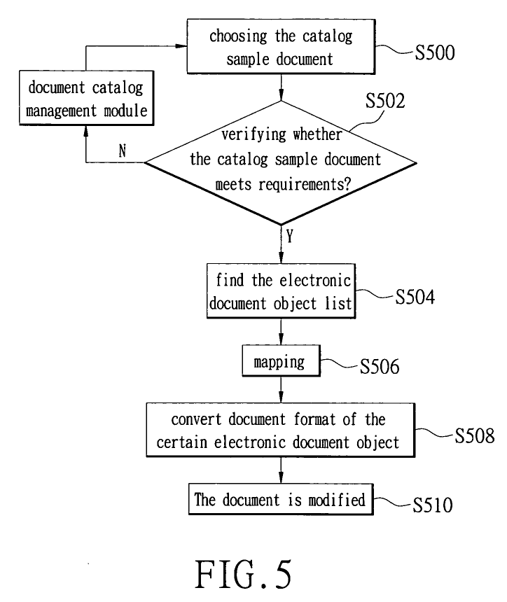

Reference is made to FIG. 5. FIG. 5 is flowchart showing a method for automatically creating a document according to one embodiment of the present invention. The processing of the flowchart is described in detail below.

Step S500: In step S500, the present invention chooses the catalog sample document 80 by the catalog sample document choosing module 20. Then, the process continues to step S502.

Step S502: In step S502, the present invention verifies whether the catalog sample document 80 meets requirements. If the catalog sample document 80 meets requirements, then the process continues to step S504. Otherwise, the process returns to step S500 through the document catalog management module 10.

Step S504: In step 504, the present invention utilizes the catalog document list creating module 30 to find the electronic document object list 90 through the search engine 61. Then, the process continues to step S506.

Step S506: In step S506, the present invention employs the catalog and document corresponding module 40 to map from at least one certain electronic document object to the items of the catalog sample document 80. Then, the process continues to step S508.

Step S508: In step S508, the present invention utilizes the document incorporating module 50 to convert a document format of the certain electronic document object by the document format conversion engine 62. Then, the process continues to step S510.

Step S510: The converted document is modified by an electronic editor.

If the converted document is not completed yet, then the process from step S504 to step S510 is repeated.

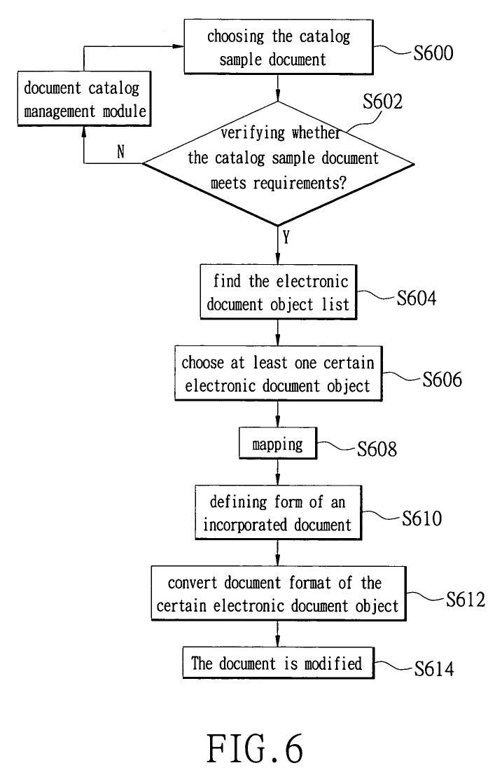

Reference is made to FIG. 6. FIG. 6 is a flowchart showing a method for automatically creating a document according to another embodiment of the present invention. The process of the flowchart is described in detail below.

Step S600: In step S600, the present invention employs the catalog sample document choosing module 20 to choose the catalog sample document 80. Then, the process continues to step S602.

Step S602: In step S602, the present invention verifies whether the catalog sample document 80 meets requirements. If the catalog sample document 80 meets requirements, then the process continues to step S604. Otherwise, the process returns to step 600 through the document catalog management module 10.

Step S604: In step S604, the present invention utilizes the catalog document list creating module 30 to find the electronic document object list 90 through the search engine 61. Then, the process continues to step S606.

Step S606: In step S606, the present invention employs the catalog and document corresponding module 40 to choose at least one certain electronic document object from the electronic document object list 90. Then, the process continues to step S608.

Step S608: In step S608, the certain electronic document object is mapped to the items of the catalog sample document 80. Then, the process continues to step S610.

Step S610: In step S610, the present invention utilizes the document incorporating module 50 to define a form of an incorporated document. Then, the process continues to step S612.

Step S612: In step S612, the document format of the certain electronic document object is converted by the document format conversion engine 62. Then, the process continues to step S614.

Step S614: The incorporated document is modified by an electronic editor.

If the incorporated document is not completed yet, then the process from step S604 to step S614 is repeated.

A method and a system for automatically creating document are described above. Contrary to the prior art, the method and the system of the present invention is configured with a capability of searching for electronic documents stored in the electronic storage device so that the electronic documents can be re-used. Less time is spent in automatically incorporating documents. Thus, regarding efficiency of creating document, the present invention dominates.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A system for automatically creating a document, with a catalog and electronic document mapping to create an electronic document, comprising:
a document catalog management module, for creating and saving catalog sample document information;
a catalog sample document choosing module, for choosing a catalog sample document;
a catalog document list creating module, for supplying a full text search condition compatible with a character set of a certain character configuration to search for a document through the search engine and electronically connected with information stored in the electronic storage device;
a catalog and document corresponding module, for previewing at least one certain electronic document object of a certain electronic document object list and mapping to items of the catalog sample document; and
a document incorporating module, converted into a document format of an electronic document edited by an electronic editor through a document format conversion engine in accordance with mapping.

2. The system for automatically creating document as claimed in claim 1, wherein the electronic storage device is Internet, intranet, local area network or personal computer.

3. The system for automatically creating document as claimed in claim 1, wherein the format of the electronic document edited by the electronic editor is at least one format of the electronic document file.

4. The system for automatically creating document as claimed in claim 1, wherein the catalog and document corresponding module is used to preview the electronic document converted by the document incorporating module.

5. A method for automatically creating document, with catalog and electronic document mapping to create electronic document, the steps comprising:
choosing a catalog sample document by a catalog sample document choosing module;
verifying whether the catalog sample document meets requirements;
using a catalog document list creating module to find an electronic document object list through a search engine;
using a catalog and document corresponding module to find at least one certain electronic object in an electronic document object list;
mapping the certain electronic document object to the items of the catalog sample document;
using a document incorporating module to define a format of the incorporated document;
converting a document format of the certain electronic document object by the document format conversion engine; and
modifying an incorporated document by an electronic editor.

6. The method for automatically creating document as claimed in claim 5, wherein if the catalog sample document meets requirements, then a process continues to a next step, and if the catalog sample document does not meet requirement, the process returns to the step of choosing a catalog sample document with the document catalog management module.

7. The method for automatically creating document as claimed in claim 5, wherein the catalog sample document or the electronic document object list is stored in an electronic storage device, and the electronic storage device is Internet, intranet, local area network or personal computer.

8. The method for automatically creating document as claimed in claim 5, wherein at least one certain electronic document object of the certain electronic document object list is listed in a catalog and document corresponding module in the step of using the catalog and document corresponding module to choose the certain electronic document object of the electronic document object list.

9. The method for automatically creating document as claimed in claim 5, wherein at least one electronic document object of the electronic document object list is previewed in the step of using the catalog and document corresponding module to choose at least one certain electronic document object of the electronic document object list.

10. The method for automatically creating document as claimed in claim 5, wherein the certain electronic document object is connected with the items of the catalog sample document by solid line in the step of mapping the certain electronic document object to the items of the catalog sample document.

11. The method for automatically creating document as claimed in claim 5, wherein the format of the document is MS-Office suite file, XML, ASP or HTML in the step of defining the form of an incorporated document by the document incorporating module.

12. The method for automatically creating document as claimed in claim 5, wherein if the document is not completed yet, then a process from the step of using the catalog document list to the step of using the electronic editor are repeated.

13. A method for automatically creating document, with catalog and electronic document mapping to create electronic document, the steps comprising:
choosing a catalog sample document by a catalog sample document choosing module;
verifying whether the catalog sample document meets requirements;
using a catalog document list creating module to find an electronic document object list through a search engine;
mapping at least one certain electronic document object to items of the catalog sample document by a catalog and document corresponding module;
using a document incorporating module to convert a document format of the certain electronic document object by a document format conversion engine; and
modifying a converted document by an electronic editor.

14. The method for automatically creating document as claimed in claim 13, wherein if the catalog sample document meets requirements, then a process continues to next step, and if the catalog sample document does not meet requirements, the process returns to the step of using a catalog sample document choosing module to choose a catalog sample document with the document catalog management module.

15. The method for automatically creating document as claimed in claim 13, wherein the catalog sample document or the electronic document object list is stored in an electronic storage device comprising Internet, intranet, local area network or personal computer.

16. The method for automatically creating document as claimed in claim 13, wherein the electronic document object is listed in the catalog and document corresponding module in the step of using the catalog and document corresponding module to map at least one certain electronic object to items of the catalog sample document.

17. The method for automatically creating document as claimed in claim 13, wherein the electronic document object is previewed in the step of using the catalog and document corresponding module to map at least one certain electronic object to items of the catalog sample document.

18. The method for automatically creating document as claimed in claim 13, wherein the certain electronic document object is connected with the catalog sample document by solid lines in the step of using the catalog and document corresponding module to map at least one certain electronic object to items of the catalog sample document.

19. The method for automatically creating document as claimed in claim 13, wherein the format of the document is MS-Office suite file, XML, ASP or HTML in step of using the document incorporating module to convert the form of the certain electronic document object by a document format conversion engine.

20. The method for automatically creating document as claimed in claim 13, wherein if the document is not completed yet, then a process from the step of using the catalog document list to the step of using the electronic editor is repeated.
